(19) United States
(12) Patent Application Publication
(10) Pub. No.: US 2019/0044873 A1
(43) Pub. Date: Feb. 7, 2019

(54) METHOD OF PACKET PROCESSING USING PACKET FILTER RULES

(71) Applicant: Intel Corporation, Santa Clara, CA (US)

(72) Inventors: John BROWNE, Limerick (IE); Chris MACNAMARA, Limerick (IE); Tomasz KANTECKI, Ennis (IE); Parthasarathy SARANGAM, Portland, OR (US)

(21) Appl. No.: 16/023,560

(22) Filed: Jun. 29, 2018

(51) Int. Cl. H04L 12/823; H04L 29/06; H04L 12/851; H04L 12/741; H04L 12/813

(52) U.S. Cl. CPC H04L 47/32; H04L 69/22; H04L 47/20; H04L 45/745; H04L 47/2441

(57) ABSTRACT

Examples may include an apparatus having processing logic to receive a packet, to classify the packet based at least in part on a header of the packet, to apply one or more serial packet filter rules to the packet, and when parallel packet filter rules are selected to apply one or more parallel packet filter rules to the packet, wherein application of the serial packet filter rules is performed in parallel with application of the parallel packet filter rules.

### TECHNICAL FIELD

Examples described herein are generally related to processing of packets in a computing system.

### BACKGROUND

In digital communications networks, packet processing refers to the wide variety of techniques that are applied to a packet of data or information as it moves through the various network elements of a communications network. There are two broad classes of packet processing techniques that align with the standardized network subdivisions of control plane and data plane. The techniques are applied to either control information contained in a packet which is used to transfer the packet safely and efficiently from origin to destination or the data content (frequently called the payload) of the packet, which is used to provide some content-specific transformation or take a content-driven action. Within any network enabled device (e.g. router, switch, firewall, network element or terminal such as a computer or smartphone) it is the packet processing subsystem that manages the traversal of the multi-layered network or protocol stack from the lower, physical and network layers all the way through to the application layer.

Packet processing systems often apply packet filter rules (PFRs) (also known as Internet Protocol (IP) filter rules, or access control lists (ACLs)) to examine incoming packets. The packet filter examines the header of each packet based on a specific set of rules, and on that basis decides to allow the packet to pass through the filter (called an Accept/Pass Action) or prevent the packet from passing through (called a Drop Action). Packet filters have a significant impact on performance, both throughput and latency, since typically all PFRs must be checked for every received packet on an interface before the packet is forwarded or terminated. Scaling up the number of rules and/or the rule complexity also significantly impacts performance.

One way to implement PFRs is by using a software-based library executing on one or more processor cores of a computing platform. One potential disadvantage is increased processor cycle count per packet when additional rules are added, which impacts throughput and packet latency. Further, more complex PFRs such as those applied to network layers four through seven increase cycle cost, decrease traffic throughput and increase packet latency.

Another way to implement PFRs is in hardware with a multistage policy engine responsible for applying PFRs by using a combination of parallel searches in memory arrays, hash tables, and ternary content-addressable memory (TCAM). The parallel search results are then evaluated and prioritized in a pipeline to create a final policy decision, which can include packet permit, packet deny, quality of service (QoS) policing, redirect, or replication (such as Switched Port Analyser (SPAN) replication). Disadvantages to this approach include additional dedicated hardware, which adds more cost to the system solution, and the number of PFRs is limited to the size of the TCAM and associated tables, resulting in a hard limit on the number of supported PFRs.

### BRIEF DESCRIPTION OF THE DRAWINGS

FIG. 1 illustrates an example of a packet processing system.

FIG. 2 illustrates an example of packet processing components in a computing platform.

FIG. 3 illustrates an example apparatus.

FIG. 4 illustrates an example flow diagram of first static logic to process a packet.

FIG. 5 illustrates another example flow diagram of second static logic to process a packet.

FIG. 6 illustrates a further example flow diagram of dynamic logic to process a packet.

FIG. 7 illustrates an example computing platform.

FIG. 8 illustrates an example of a storage medium.

FIG. 9 illustrates another example computing platform.

FIG. 10 illustrates an example distributed software implementation.

FIG. 11 illustrates an example hardware implementation.

### DETAILED DESCRIPTION

As contemplated in the present disclosure, application of packet filter rules (PFRs) to incoming packets may be split into serial and parallel processing paths, thereby allowing PFRs to complete much faster than processing all PFRs in series at the start of the packet processing pipeline. Embodiments of the present invention introduces PFRs processing logic to divide PFR checking between serial and parallel paths. In an embodiment, this approach also includes load distribution and balancing between serial and parallel paths. In embodiments, there are two types of operation, static and dynamic. In static mode, the PFR processing logic takes a fixed set of PFRs and divides checking of PFRs into serial and parallel paths based at least in part on one or more of the number of PFRs, rule complexity, and execution time. Other factors may also be considered in the serial/parallel path decision. In dynamic mode, the PFR processing logic dynamically adds additional security rules when an attack is detected.

Splitting the PFRs into serial and parallel paths results in several advantages. Performance of the PFRs is accelerated, PFRs are scaled by parallelizing operation of the PFRs, and additional PFRs may be added dynamically without impacting system performance. Further advantages include improving the security of a processor, a network interface card (NIC), or an accelerator by adding additional PFR checking when an attack is in progress, and implementing autonomous operation, whereby no external re-configuration is required when operating in dynamic mode.

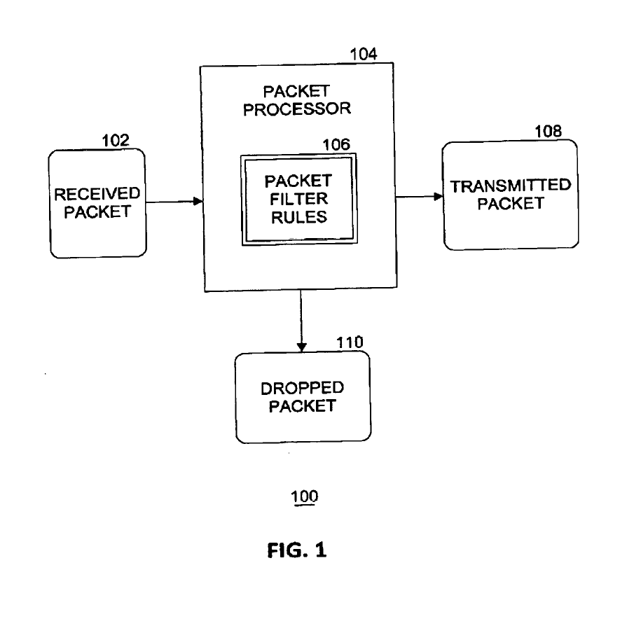

FIG. 1 illustrates an example of a packet processing system. A packet includes a packet header and a packet payload. A packet processor component 104 examines a received packet 102 by applying one or more packet filter rules 106 (PFRs) to one or more of the packet header and packet payload. Based on application of the PFRs, packet processor 104 either transmits the packet (e.g., as transmitted packet 108) onward in a computing system for further processing or drops the packet (shown as dropped packet 110 in FIG. 1) whereby the packet is discarded and deleted, resulting in no further processing of the dropped packet. PFRs 106 may include many types of rules, such as range filtering rules, anti-spoof rules, smurf/Internet Control Message Processing (ICMP) rules, blacklist rules, white list rules, fragment rules, port forwarding rules, policy-based routing rules, and so on. Each PFR explicitly states the direction of traffic using keywords such as (a) “in” whereby the PFR is applied against an inbound packet; (b) “out” whereby the PFR is applied against an outbound packet; and (c) “all” whereby the PFR applies to either direction. If a packet processor 104 has multiple interfaces (input and/or output), the interface can be specified in the PFR along with the direction.

An example of a Layer 3 PFR is as follows:

ACTION DIRECTION OPTIONS proto PROTO_TYPE from SRC_ADDR SRC_PORT to DST_ADDR DST_PORT TCP_FLAG|ICMP_TYPE keep state STATE

The action keyword indicates what to do with received packet 102 if the packet matches the PFR. Every PFR must have an associated action. In an embodiment, the following actions are recognized: (a) block: drops the packet; (b) pass: allows the packet; (c) log: generates a log record; (d) count: counts the number of packets and bytes which can provide an indication of how often a PFR is used; (e) auth: queues the packet for further processing by another program; (f) call: provides access to functions that allow more complex actions; and (g) decapsulate: removes any headers in order to process the contents of the packet. In other embodiments, other actions may be defined. Generally, every PFR is read in order, with the last matching PFR being the one that is applied to the packet. This means that even if the first PFR to match a packet is a pass, if there is a later matching PFR that is a block, the packet will be dropped. In an embodiment, quick PFRs may be defined so that if a packet matches a quick PFR, the action specified by the quick PFR is implemented and no further processing of any following PFRs will be applied to this packet. This optimization increases the throughput of packet processor 104.

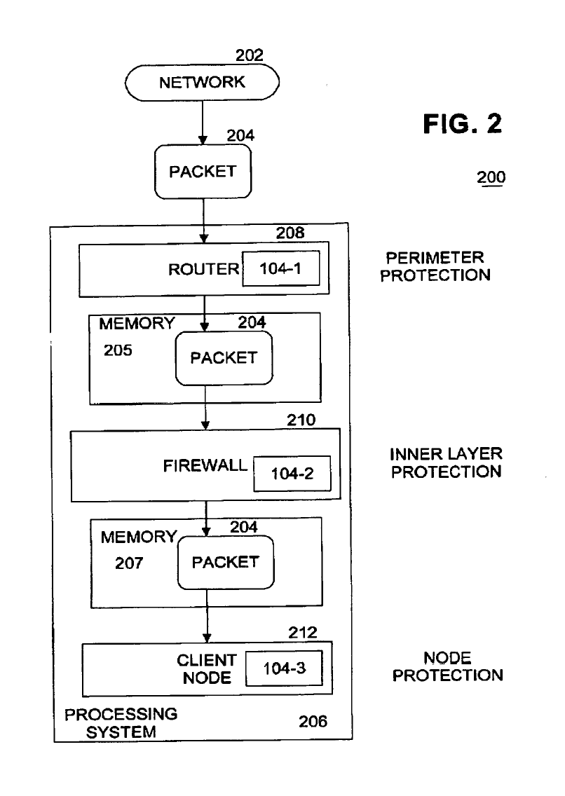

FIG. 2 illustrates an example of packet processing components in a computing platform. An incoming packet 204 is received from a network 202, such as the Internet, for example, by processing system 206. Processing system 206 may be any digital electronics device capable of processing data. Processing system 206 includes one or more components that processes packet 204.

For example, processing system 206 includes router 208. Router 208 is a networking device that forwards data packets between computer networks. Routers perform the traffic directing functions on the Internet. A data packet is typically forwarded from one router to another router through the networks that constitute an internetwork until it reaches its destination node. A router is connected to two or more data lines from different networks. When a data packet comes in on one of the lines, the router reads the network address information in the packet to determine the ultimate destination. Then, using information in its routing table or routing policy, it directs the packet to the next network on its journey. The most familiar type of routers are home and small office routers that simply forward Internet Protocol (IP) packets between the home computers and the Internet. An example of a router would be the owner's cable or DSL router, which connects to the Internet through an Internet service provider (ISP). More sophisticated routers, such as enterprise routers, connect large business or ISP networks up to the powerful core routers that forward data at high speed along the optical fiber lines of the Internet backbone.

In an embodiment, router 208 includes packet processor 104-1 (i.e., an instantiation of packet processor 104). Router 208 provides perimeter protection. Router 208 forwards packet 204 to firewall 210 if the packet passes the PFRs applied by packet processor 104-1 in the router. In an embodiment, packet 204 is stored, at least temporarily, in memory 205. In another embodiment, route 208 may be replaced by a switch.

For example, processing system 200 also includes firewall 210. Firewall 210 is a network security system that monitors and controls incoming and outgoing network traffic based on predetermined security rules. A firewall typically establishes a barrier between a trusted internal network and untrusted external network, such as the Internet. Firewalls are often categorized as either network firewalls or host-based firewalls. Network firewalls filter traffic between two or more networks and run on network hardware. Host-based firewalls run on host computers and control network traffic in and out of those machines.

In an embodiment, firewall 210 includes packet processor 104-2. Firewall 210 provides inner layer protection. Firewall 210 forwards packet 204 to client node 212 if the packet passes the PFRs applied by packet processor 104-2 in the firewall. Note that the set of PFRs applied by packet processor 104-2 in firewall 210 may be different than the set of PFRs applied by packet processor 104-1 in router 208. In an embodiment, packet 204 is stored, at least temporarily, in memory 207. In an embodiment, memory 205 and memory 207 may be the same memory.

For example, processing system 200 also includes client node 212. Client node 212 may be a computing system such as a laptop or desktop personal computer, smartphone, tablet computer, digital video recorder (DVR), computer server, web server, consumer electronics device, or other content producer or consumer.

In an embodiment, client node 212 includes packet processor 104-3. Client node 212 provides node protection. Note that the set of PFRs applied by packet processor 104-3 in client node 212 may be different than the set of PFRs applied by either packet processor 104-1 in router 208 or packet processor 104-2 in firewall 210.

Although router 208, firewall 210, and client node 212 are all shown in the example processing system 206 in a pipeline design, packet processor 104 according to the present disclosure may be included “stand-alone” in processing system 206, or in any combination of zero or more of router 208, firewall 210, client node 104, or in other components in processing system 206. In the example shown in FIG. 2, once packet processor 104-1 in router 208, packet processor 104-2 in firewall 210, and packet processor 104-3 in client node 212 all examine and pass the packet, then client node 212 can use the packet's payload for further processing in the client node. In various embodiments, router 208, firewall 210, and client node 212 are implemented by one or more of hardware circuitry, firmware, and software, including network virtualized functions (NVFs).

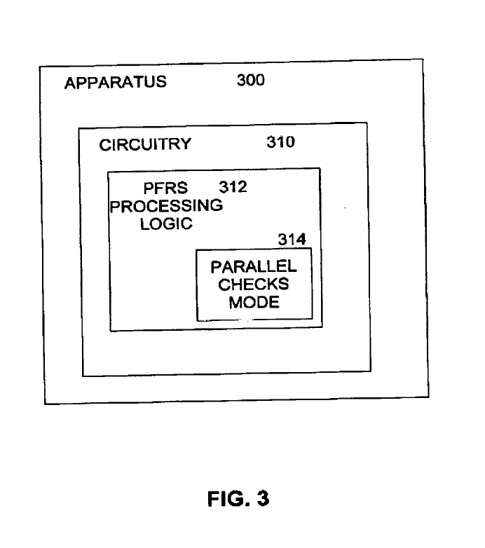

FIG. 3 illustrates an example apparatus. Although apparatus 300 shown in FIG. 3 has a limited number of elements in a certain topology, it may be appreciated that the apparatus 300 may include more or less elements in alternate topologies as desired for a given implementation.

According to some examples, apparatus 300 is associated with logic and/or features of packet filter rules processing logic 312. In an embodiment, packet filter rules processing logic 312 is implemented as packet processor 104 as shown in FIG. 1, and/or packet processor 104-1, 104-2, and 104-3 as shown in FIG. 2, hosted by a processing system such as processing system 206, and supported by circuitry 310. Packet filter rules processing logic 312 applies packet filter rules 106 to received packet 102. For these examples, circuitry 310 is incorporated within one or more of circuitry, processor circuitry, a processing element, a processor, a central processing unit (CPU) or a core maintained at processing system 206. Circuitry 310 is arranged to execute one or more software, firmware or hardware implemented modules, components or PFRs processing logic 312. Module, component or logic may be used interchangeably in this context. The examples presented are not limited in this context and the different variables used throughout may represent the same or different integer values. Also, “logic”, “module” or “component” also includes software/firmware stored in computer-readable media, and although the types of logic are shown in FIG. 3 as discrete boxes, this does not limit these components to storage in distinct computer-readable media components (e.g., a separate memory, etc.).

Circuitry 310 is all or at least a portion of any of various commercially available processors, including without limitation an Intel® Atom®, Celeron®, Core (2) Duo®, Core i3, Core i5, Core i7, Itanium®, Pentium®, Xeon®, Xeon Phi® and XScale® processors; or similar processors, or Advanced Reduced Instruction Set Computing (RISC) Machine (ARM) processors. According to some examples, circuitry 210 also includes an application specific integrated circuit (ASIC) and at least some of PFRs processing logic 312 is implemented as hardware elements of the ASIC. According to some examples, circuitry 310 also includes a field programmable gate array (FPGA) and at least some PFRs processing logic 312 is implemented as hardware elements of the FPGA.

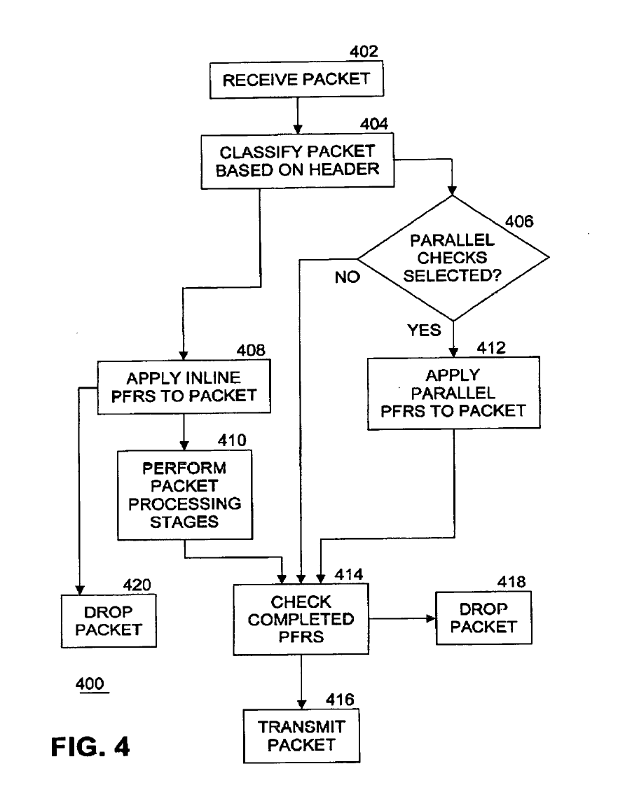

According to some examples, apparatus 300 includes PFRs processing logic 312. Packet filter rules (PFRs) processing logic 312 is executed or implemented by circuitry 310 to perform processing as described with reference to FIGS. 4-6 described below. PFRs processing logic 312 also includes parallel checks mode indicator 314. Parallel checks mode indicates whether parallel checking of PFRs is to be done by apparatus 300. In an embodiment, when parallel checks mode is set, then PFRs processing logic 312 performs parallel checks of PFRs. [003s] Various components of apparatus 300 may be communicatively coupled to each other by various types of communications media to coordinate operations. The coordination may involve the uni-directional or bi-directional exchange of information. For instance, the components may communicate information in the form of signals communicated over the communications media.

The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

FIG. 4 illustrates an example flow diagram of first static logic 400 to process a packet. In an embodiment, logic 400 is implemented as PFRs processing logic 312. At block 402, a packet 102 is received. At block 404, PFRs processing logic 312 classifies the packet based at least in part on the packet header. For example, classification may be performed according to packet attributes such as priority, port number, protocol, network layer, Outer Layer 2.5 header Protocol type (such as multiprotocol layer switching (MPLS), network service header (NSH)), Layer 2.5 priority (such as MPLS priority), Source media access control (MAC), Destination MAC, Packet length, IP Diff Serve Code Point (DSCP), IP Protocol type, IP serial peripheral interface (SPI) type, Institute of Electrical and Electronics Engineers (IEEE) Working Group 802.1 standard Ethernet priority bits (pbits), and so on. At block 408, PFRs processing logic 312 applies serial inline PFRs to the packet. Examples of serial inline PFRs include Network Working Group Request for Comment (RFC) 3704/2827 Addr Range Filtering Rules, RFC 3704/2827 Anti-Spoof rules, white list and black list rules. PFRs processing logic 312 applies each PFR in a set of one or more PFRs in series for the serial inline mode to the packet header. In an embodiment, PFRs processing logic 312 also applies one or more PFRs to the packet payload. In an embodiment, the serial inline PFRs are applied to the packet by executing PFRs processing logic 312 on a first core of a processor in circuitry 310. If the packet fails to pass any PFR in the series, the packet is dropped at block 420 and packet processing terminates. Next, at block 410 PFRs processing logic 312 performs packet processing stages on the packet. For example, packet processing stages include one or more of encryption, selecting a tunnel, traffic management, Quality of Service (QoS) decision making, fragmentation and reassembly, Deep Packet Inspection (DPI), packet scheduling, traffic shaping, data record generation for billing and so on.

In parallel with processing of blocks 408, 410, and 420, PFRs processing logic 312 also processes block 406 and optionally block 412. Parallel checks mode 314 may be previously set by logic within packet processor 104. In an embodiment, this setting may be performed during initialization of packet processor 104. In another embodiment, this setting may be modified by any combination of one or more of firmware, software, and hardware as a result of user interaction with packet processor 104. If parallel checks mode 314 is set, this condition is detected at block 406, and one or more parallel PFRs are applied to the packet at block 412. Examples of parallel PFRs include additional white list and black list checks for IP addresses and MAC address, and Layer 3 to Layer 7 policy-based rules. In an embodiment, the one or more parallel PFRs are applied by executing portions of PFRs processing logic 312 on at least a second core (or more cores) of one or more processors in packet processor 104. For example, if four parallel PFRs are to be applied to a packet, each PFR may be applied to the packet on a different one of four cores and executed in parallel with the others. In this way packet processing throughput is significantly increased and latency is decreased by using multiple cores in parallel.

If parallel checks mode 314 is not set, then parallel PFRs are not applied to the packet at block 412. In either case, and after packet processing stages have been performed at block 410, processing continues with block 414. At block 414, the status of completed PFRs (whether serial inline or parallel) are checked. Thus block 414 is a point of synchronization of the serial inline and parallel processing paths. If application of any PFR to the packet has failed, the packet is dropped at block 418 and packet processing terminates. If application of all PFRs are successful, then the packet is transmitted at block 416. In an embodiment, the rate at which successful packets are transmitted may be controlled or limited according to a packet processing policy. If the status of processing the packet is any one of (c) through (g) above, the specified action will be performed.

In an embodiment, instead of implementing the serial inline PFRs one after the other in sequence, the serial inline PFRs may be distributed among multiple processing cores and implemented in parallel with each other.

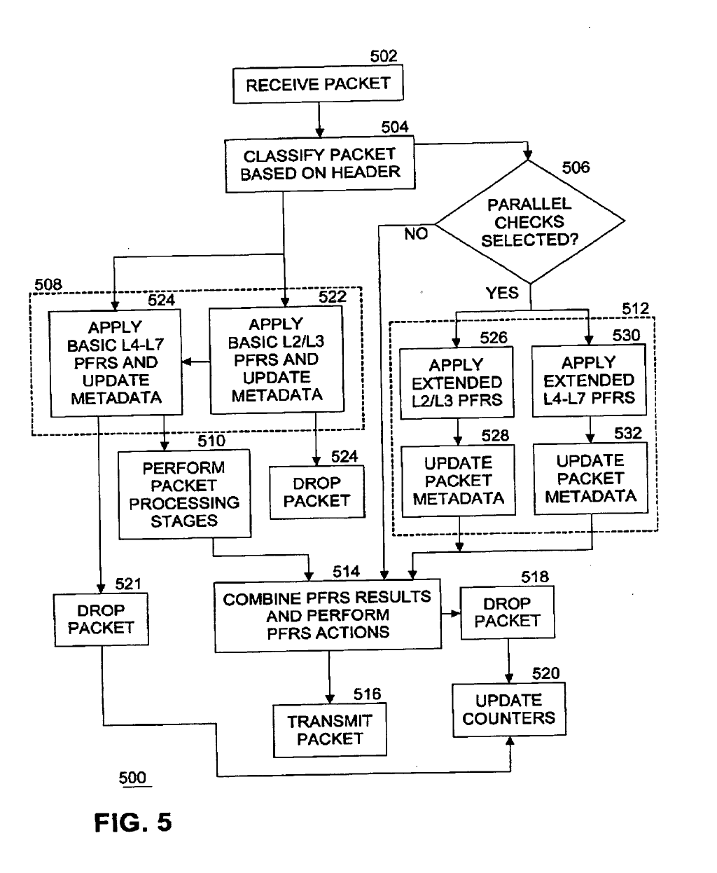

FIG. 5 illustrates another example flow diagram of second static logic 500 to process a packet. FIG. 5 illustrates further details of the example shown in FIG. 4. In an embodiment, logic 500 is implemented as PFRs processing logic 312. At block 502, a packet 102 is received. At block 504, PFRs processing logic 312 classifies the packet based at least in part on the packet header. For example, classification may be performed according to packet attributes such as priority, port number, protocol, network layer, Outer Layer 2.5 header Protocol type (such as multiprotocol layer switching (MPLS), network service header (NSH)), Layer 2.5 priority (such as MPLS priority), Source media access control (MAC), Packet length, IP Diff Serve Code Point (DSCP), IP Protocol type, IP serial peripheral interface (SPI) type, IEEE Working Group 802.1 standard Ethernet priority bits (pbits), and so on. At block 508, PFRs processing logic 312 applies serial inline PFRs to the packet. PFRs processing logic 312 applies each PFR in a set of one or more PFRs in series for the serial inline mode to the packet header. In an embodiment, PFRs processing logic 312 also applies one or more PFRs to the packet payload. In an embodiment, the serial inline PFRs are applied to the packet by executing PFRs processing logic 312 on a first core of a processor in circuitry 310. If the packet fails to pass any PFR in the series, the packet is dropped at block 521 and packet processing terminates.

In an embodiment, block 508 is implemented by dividing application of PFRs to the packet into at least two stages. In the example shown in FIG. 5, there are two stages, but in other examples the PFRs may be divided into other numbers of stages. For example, at block 522, PFRs processing logic 312 applies one or more basic level 2 and level 3 (L2/L3) PFRs to the packet. Examples of basic L2/L3 PFRs include RFC 3704/2827 Addr Range Filtering, RFC 3704/2827 Anti-Spoof Rules, and so on. Anti-Spoofing includes the tasks of one or more of blocking all inbound traffic where the source address is from the internal networks, blocking all outbound traffic where the source address isn't from the internal networks, blocking all inbound and outbound traffic where the source or destination addresses are from the private address ranges, and blocking all source-routed packets. Anti-Smurf Attack processing includes the task of blocking all broadcast packets, including directed broadcasts. PFRs processing logic 312 updates metadata associated with the packet to indicate the status of the applied PFRs. Metadata includes information related to the processing of the packet, such as an identifier, a source, a destination. In an embodiment, the metadata contains information on the packet size, the port that received the packet, the port that is to transmit the packet, the linking of buffers into larger packets, etc. For example, the metadata includes one or more of Packet offset, Packet Length (Packet Size), Input Port (Local RX Port), Output Port (Local TX Port), Packet Handle, Packet Data: 5 Tuple—Contained in the Packet header including Source IP address, Source IP port number, Destination IP address, Destination IP port number, protocol ID, next hop, and coloring for congestion management such as weighted random early detection (WRED).

If the packet fails to pass any of the basic L2/L3 PFRs, the packet is dropped at block 524 and packet processing terminates. If the packet passes the basic L2/L3 PFRs, processing continues at block 524 where PFRs processing logic 312 applies one or more basic level 4, level 5, level 6, and level 7 (L4-L7) PFRs to the packet. Examples of basic L4-L7 PFRs include policy-based rules. Unlike traditional destination IP based routing, PFRs are used to determine the routing path. A PFR characterizes the packet on its source/destination IP address, L4 protocol and ports, and also the kind of application (L7). Policy-based routing (PBR) can route unicast traffic along a different path than a routing protocol would use. PBR route maps can be configured to do the following: Allow or deny paths based on the identity of a particular end system, an application protocol, or the size of packets or a combination of these values; classify traffic based on extended access list criteria; set IP precedence bits; and route packets to specific paths.

PFRs processing logic 312 updates metadata associated with the packet to indicate the status of the applied L4-L7 PFRs. If the packet fails to pass any of the basic L4-L7 PFRs, the packet is dropped at block 521, one or more counters associated with packet processing are updated at block 520, and packet processing terminates. Counters may include one or more of packet processing statistics, telemetry information, status of PFRs, and so on. In an embodiment, counters can record drops on input and output interfaces, a reason for drop, and local billing records of subscribers drop counters per transport layer counters (L3-L7).

Next, if the packet passes all basic L2/L3 and L4-L7 PFRs, at block 510 PFRs processing logic 312 performs packet processing stages on the packet. For example, packet processing stages include one or more of encryption, selecting a tunnel, traffic management, Quality of Service (QoS) decision making, fragmentation and reassembly, Deep Packet Inspection (DPI), packet scheduling, traffic shaping, data record generation for billing, compression and so on.

In parallel with processing of blocks 508, 510, 520, 521, and 524, PFRs processing logic 312 also processes block 506 and optionally block 512. Parallel checks mode 314 may be previously set by logic within packet processor 104. In an embodiment, this setting may be performed during initialization of packet processor 104. In another embodiment, this setting may be modified by any combination of one or more of firmware, software, and hardware as a result of user interaction with packet processor 104. If parallel checks mode 314 is set, this condition is detected at block 506, and one or more parallel PFRs are applied to the packet at block 512. In an embodiment, the one or more parallel PFRs are applied by executing portions of PFRs processing logic 312 on at least a second core (or more cores) of one or more processors in packet processor 104. For example, if four parallel PFRs are to be applied to a packet, each PFR may be applied to the packet on a different one of four cores and executed in parallel with the others. In this way packet processing throughput is significantly increased and latency is decreased by using multiple cores in parallel.

In an embodiment, block 508 is implemented by dividing application of PFRs to the packet into at least two stages performed in series on one core or in parallel on different cores. In the example shown in FIG. 5, there are two stages, but in other examples the PFRs may be divided into other numbers of stages. For example, at block 526, PFRs processing logic 312 applies one or more extended L2/L3 PFRs to the packet. Examples of extended L2/L3 PFRs include IP and MAC address based white lists and black lists. L3-L7 Deep packet inspection rules.

PFRs processing logic 312 updates metadata associated with the packet to indicate the status of the applied PFRs at block 528. For example, at block 530, PFRs processing logic 312 applies one or more extended L4-L7 PFRs to the packet. Examples of extended L4-L7 PFRs include policy-based rules. PFRs processing logic 312 updates metadata associated with the packet to indicate the status of the applied L4-L7 PFRs at block 532. In an embodiment, application of extended L2/L3 PFRs is executed on a first core and application of extended L4-L7 PFRs is executed a second core, the applications being performed in parallel. In another embodiment, application of extended L4-L7 PFRs are distributed among a plurality of cores and performed in parallel.

If parallel checks mode 314 is not set, then parallel PFRs are not applied to the packet at block 512. In either case, and after packet processing stages have been performed at block 510, processing continues with block 514. At block 514, the status of completed PFRs (whether serial inline or parallel) are checked, using the metadata associated with the packet. Thus block 514 is a point of synchronization of the serial inline and parallel processing paths. If application of any PFR to the packet has failed, the packet is dropped at block 518, one or more counters associated with packet processing are updated at block 520, and packet processing terminates. If application of all PFRs are successful, then the packet is transmitted at block 516. In an embodiment, the rate at which successful packets are transmitted may be controlled or limited according to a packet processing policy. If the status of processing the packet is any one of (c) through (g) above, the specified action will be performed.

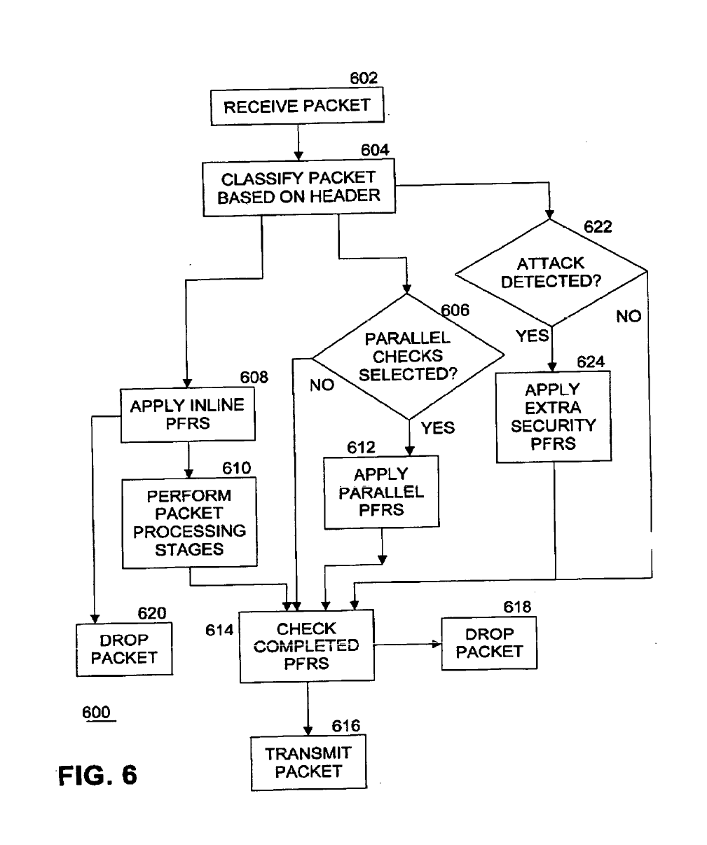

FIG. 6 illustrates a further example flow diagram of dynamic logic 600 to process a packet. In an embodiment, logic 600 is implemented as packet filter rules (PFRs) processing logic 312. At block 602, a packet 102 is received. At block 604, PFRs processing logic 312 classifies the packet based at least in part on the packet header. For example, classification may be performed according to packet attributes such as priority, port number, protocol, network layer, Outer Layer 2.5 header Protocol type (such as multiprotocol layer switching (MPLS), network service header (NSH)), Layer 2.5 priority (such as MPLS priority), Source media access control (MAC), Packet length, IP Diff Serve Code Point (DSCP), IP Protocol type, IP serial peripheral interface (SPI) type, IEEE Working Group 802.1 standard Ethernet priority bits (pbits), and so on. At block 608, PFRs processing logic 312 applies serial inline PFRs to the packet. PFRs processing logic 312 applies each PFR in a set of one or more PFRs in series for the serial inline mode to the packet header. In an embodiment, PFRs processing logic 312 also applies one or more PFRs to the packet payload. In an embodiment, the serial inline PFRs are applied to the packet by executing PFRs processing logic 312 on a first core of a processor in circuitry 310. If the packet fails to pass any PFR in the series and only serial inline PFRs are to be applied to the current packet, the packet is dropped at block 620 and packet processing terminates. Next, at block 610 PFRs processing logic 312 performs packet processing stages on the packet. For example, packet processing stages include one or more of encryption, selecting a tunnel, traffic management, Quality of Service (QoS) decision making, fragmentation and reassembly, Deep Packet Inspection (DPI), packet scheduling, traffic shaping, data record generation for billing and so on.

In parallel with processing of blocks 608, 610, and 620, PFRs processing logic 312 also processes block 606 and optionally block 612. Parallel checks mode 314 may be previously set by logic within packet processor 104. In an embodiment, this setting may be performed during initialization of packet processor 104. In another embodiment, this setting may be modified by any combination of one or more of firmware, software, and hardware as a result of user interaction with packet processor 104. If parallel checks mode 314 is set, this condition is detected at block 606, and one or more parallel PFRs are applied to the packet at block 612. In an embodiment, the one or more parallel PFRs are applied by executing portions of PFRs processing logic 312 on at least a second core (or more cores) of one or more processors in packet processor 104. For example, if four parallel PFRs are to be applied to a packet, each PFR may be applied to the packet on a different one of four cores and executed in parallel with the others. In this way packet processing throughput is significantly increased and latency is decreased by using multiple cores in parallel. If parallel checks mode 314 is not set, then parallel PFRs are not applied to the packet at block 612.

In parallel with processing of blocks 606, 608, 610, 620, and optionally 612, PFRs processing logic 312 also processes blocks 622 and optionally 624. Processing of blocks 622 and optionally 624 may be performed in parallel on a core different than the cores processing blocks 606, 608, 610, 620, and 612. In an embodiment, packet processor 104 includes logic to detect attacks against processing system 206 (such as denial of service (DoS) attacks, for example). If an attack is detected, then PFRs processing logic 312 applies one or more extra security PFRs to the packet at block 624. The extra security PFRs may be previously defined as a set of security PFRs, and packet processor 104 and/or PFRs processing logic 312 may include logic to dynamically select which one or more of the defined set of extra security PFRs to apply at block 624 depending on the characteristics of the detected attack. In this way there may be many variations of sets of extra security PFRs that can be applied to the packet in different situations. In an embodiment, new security PFRs may be defined and applied by PFRs processing logic 312 dynamically (e.g., “on-the-fly”) or via user interaction. If no attack is detected at block 622, block 624 is skipped.

In any case, and after packet processing stages have been performed at block 610, processing continues with block 614. At block 614, the status of completed PFRs (whether serial inline or parallel) are checked. Thus block 614 is a point of synchronization of the serial inline and parallel processing paths. If application of any PFR to the packet has failed, the packet is dropped at block 618 and packet processing terminates. If application of all PFRs are successful, then the packet is transmitted at block 616. In an embodiment, the rate at which successful packets are transmitted may be controlled or limited according to a packet processing policy. If the status of processing the packet is any one of (c) through (g) above, the specified action will be performed.

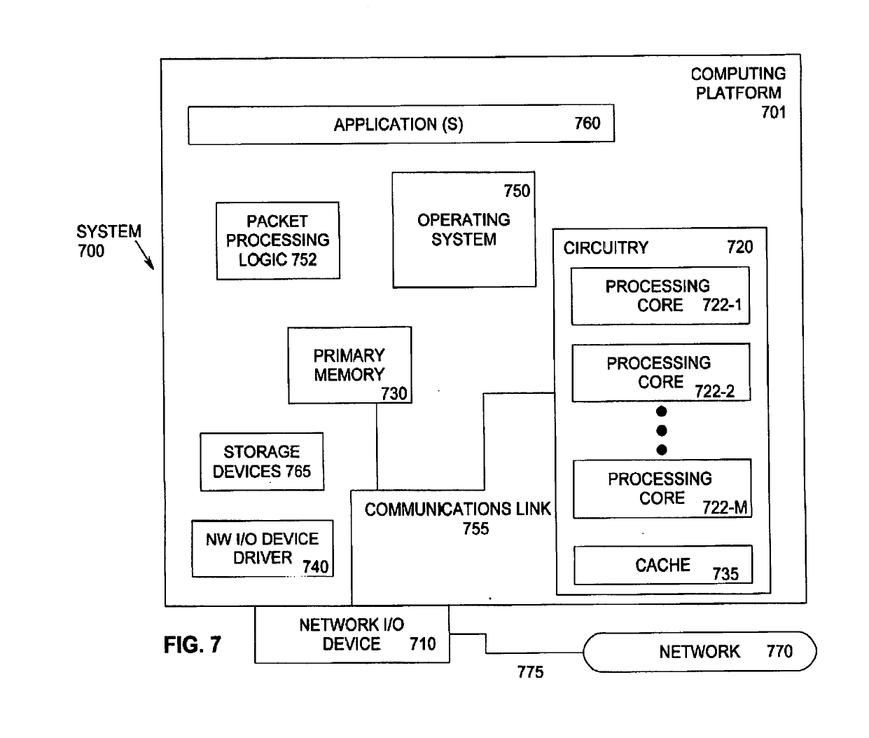

FIG. 7 illustrates an example computing system 700. As shown in FIG. 7, computing system 700 includes a computing platform 701 coupled to a network 770. In some examples, as shown in FIG. 7, computing platform 701 may couple to network 770 (which may be the same as network 202 of FIG. 2, e.g., the Internet) via a network communication channel 775 and through a network I/O device 710 (e.g., a network interface controller (NIC)) having one or more ports connected or coupled to network communication channel 775.

According to some examples, computing platform 701, as shown in FIG. 7, may include circuitry 720, primary memory 730, a network (NW) I/O device driver 740, an operating system (OS) 750, one or more application(s) 760, storage devices 765, and packet processing logic 752. In an embodiment, packet processor 104 of FIG. 1 is implemented as packet processing logic 752, and packet filter rules (PFRs), packets, and packet metadata are stored in one or more of primary memory 730 and/or storage devices 765. In at least one embodiment, storage devices 765 may be one or more of hard disk drives (HDDs) and/or solid-state drives (SSDs). In an embodiment, storage devices 765 may be non-volatile memories (NVMs). In some examples, as shown in FIG. 7, circuitry 720 may communicatively couple to primary memory 730 and network I/O device 710 via communications link 755. Although not shown in FIG. 7, in some examples, operating system 750, NW I/O device driver 740 or application(s) 760 may be implemented, at least in part, via cooperation between one or more memory devices included in primary memory 730 (e.g., volatile or non-volatile memory devices) and elements of circuitry 720 such as processing cores 722-1 to 722-m, where “m” is any positive whole integer greater than 2. In an embodiment, packet processing logic 752 may be executed by one or more processing cores 722-1 to 722-m to process packets by applying PFRs to the packets.

In some examples, computing platform 701, may include, but is not limited to, a server, a server array or server farm, a web server, a network server, an Internet server, a work station, a mini-computer, a main frame computer, a supercomputer, a network appliance, a web appliance, a distributed computing system, multiprocessor systems, processor-based systems, a laptop computer, a tablet computer, a smartphone, or a combination thereof. Also, circuitry 720 having processing cores 722-1 to 722-m may include various commercially available processors, including without limitation Intel® Atom®, Celeron®, Core (2) Duo®, Core i3, Core i5, Core i7, Itanium®, Pentium®, Xeon® or Xeon Phi® processors; ARM processors, and similar processors. Circuitry 720 may include at least one cache 735 to store data.

According to some examples, primary memory 730 may be composed of one or more memory devices or dies which may include various types of volatile and/or non-volatile memory. Volatile types of memory may include, but are not limited to, dynamic random-access memory (DRAM), static random-access memory (SRAM), thyristor RAM (TRAM) or zero-capacitor RAM (ZRAM). Non-volatile types of memory may include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), magneto-resistive random-access memory (MRAM) that incorporates memristor technology, spin transfer torque MRAM (STT-MRAM), or a combination of any of the above. In another embodiment, primary memory 730 may include one or more hard disk drives within and/or accessible by computing platform 701.

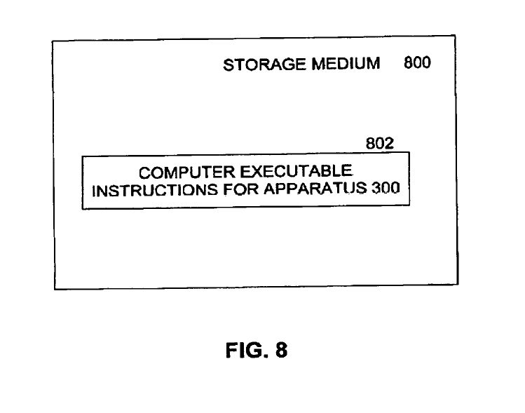

FIG. 8 illustrates an example of a storage medium 800. Storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions 802 for apparatus 300 to implement logic flows 400, 500, and 600, of FIG. 4, FIG. 5, and FIG. 6, respectively. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

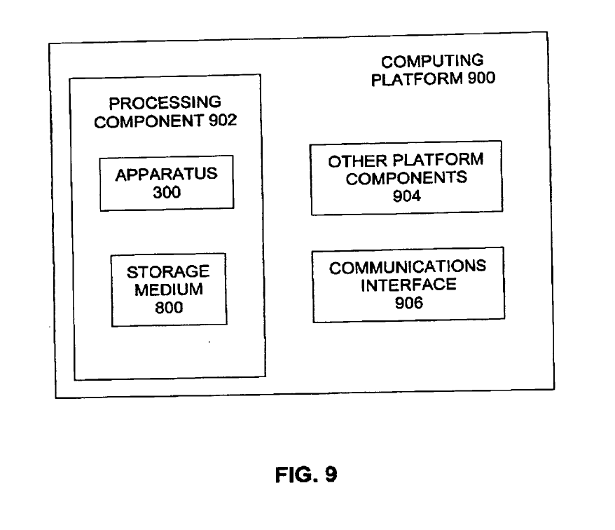

FIG. 9 illustrates an example computing platform 900. In some examples, as shown in FIG. 9, computing platform 900 may include a processing component 902, other platform components 904 and/or a communications interface 906.

According to some examples, processing component 902 may execute processing operations or logic for apparatus 300 and/or storage medium 800. Processing component 902 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 904 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), types of non-volatile memory such as 3-D cross-point memory that may be byte or block addressable. Non-volatile types of memory may also include other types of byte or block addressable non-volatile memory such as, but not limited to, multi-threshold level NAND flash memory, NOR flash memory, single or multi-level PCM, resistive memory, nanowire memory, FeTRAM, MRAM that incorporates memristor technology, STT-MRAM, or a combination of any of the above. Other types of computer readable and machine-readable storage media may also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 906 may include logic and/or features to support a communication interface. For these examples, communications interface 906 may include one or more communication interfaces that operate according to various communication protocols or standards to communicate over direct or network communication links or channels. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Switch Specification.

The components and features of computing platform 900 may be implemented using any combination of discrete circuitry, ASICs, logic gates and/or single chip architectures. Further, the features of computing platform 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

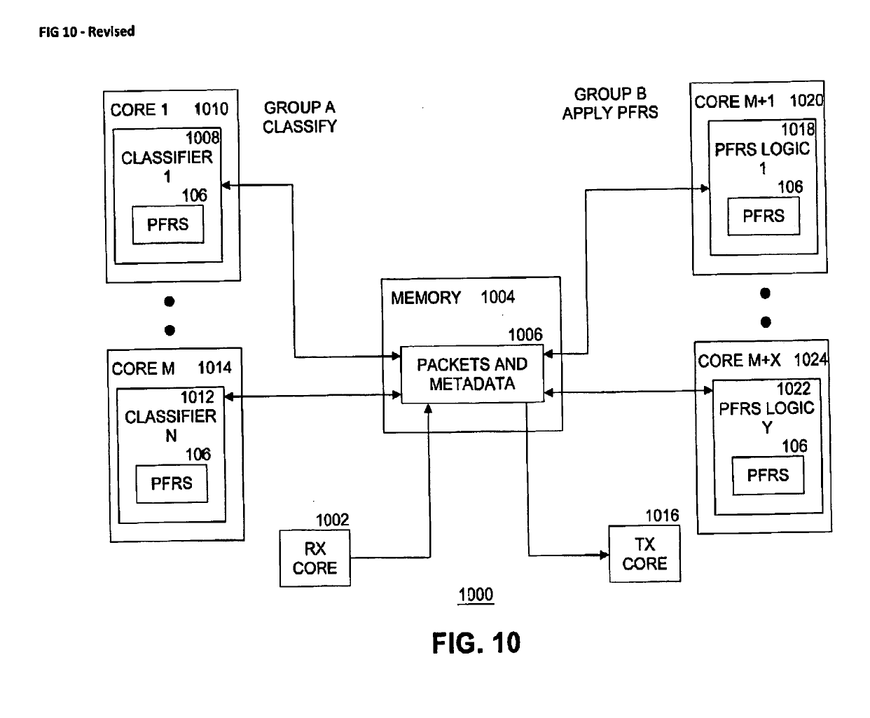

FIG. 10 illustrates an example distributed software implementation. In this example, processing described above with reference to FIG. 1-6 may be distributed among multiple processing cores to improve efficiency of the system. Processing logic to receive data packets is implemented on a receive (RX) core 1002. Data packets and metadata are stored in memory 1004. Classifier logic is executed by one or more cores in a group of cores called group A. For example, classifier 1 1008 running on core 1 1010 uses PFRs 106 and packets and metadata 1006 to classify packets. In parallel, core M 1014, where M is a natural number, executes classifier N 1012, where N is a natural number. In embodiments, there may be only one classifier per core, or there may be any number of classifiers per core. In embodiments, there may be any number of cores performing classifier functions.

Another group of cores, called group B in this example, execute logic to apply PFRs 106 to packets. For example, PFRs logic 1 1018 running on core M+1 1020 uses PFRs 106 and packets and metadata 1006 to apply selected PFRs as described above in FIG. 4-6. In parallel, core M+X, where X is a natural number, executes PFRS logic Y, where Y is a natural number. In embodiments, there may be only one PFRs logic per core, or there may be any number of PFRs logic components per core. In embodiments, there may be any number of cores performing PFRs logic functions. In various embodiments, any core in the system 1000 may include a mix of zero or more classifiers and PFRs logic components, depending on the processing requirements of the system.

In various embodiments, PFRs 106 may be the same set of PFRs in each classifier, the same set of PFRs in each PFRs logic component or may be different sets or subsets of PFRs in each, depending on system requirements.

Packets and metadata 1006 are stored in memory 104 in such as way as to be accessible by multiple logic components, such as using a transactional content addressable memory (TCAM), for example. Other techniques for data structures and data access may also be used.

Thus, system 1000 provides for scalability of processing data packets using PFRs since classifier and PFRs processing logic functions can be distributed across multiple cores and performed in parallel.

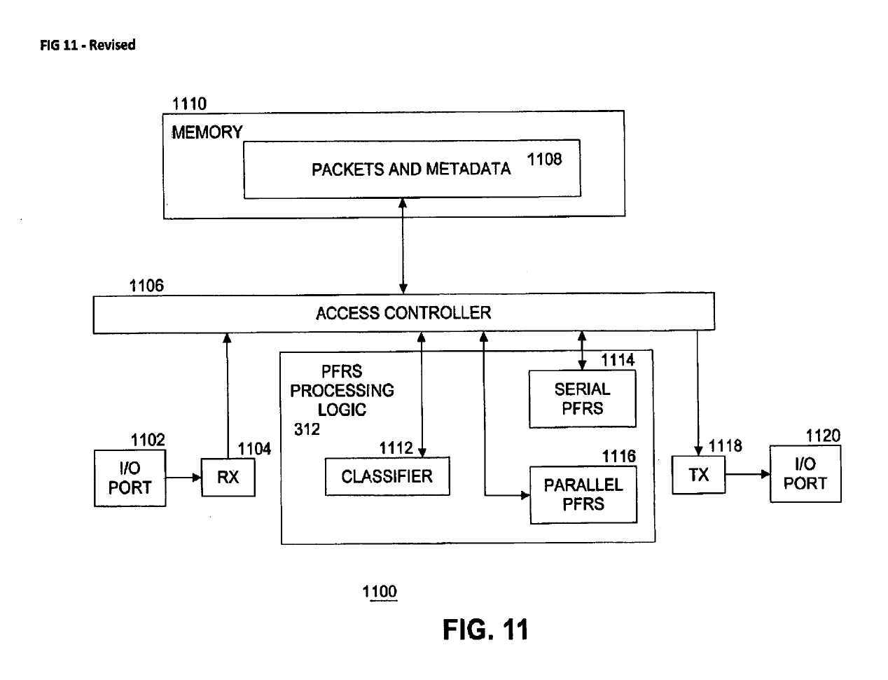

FIG. 11 illustrates an example hardware implementation. System 1100 include an I/O port 1102 to receive data packets. Data packets are forwarded by receive (RX) circuitry 1104 in memory 1110 via access controller 1106. Access controller may be any interconnect fabric to transfer data between system components. Once data and metadata 1108 is stored in memory 1110, PFRs processing logic 312, implemented as circuitry, accesses the packets and metadata to perform processing as described above with reference to FIG. 4-6. Packets are forwarded by transmit (TX) circuitry 1118 to I/O port 1120 for further use.

In an embodiment, PFRs processing logic 312 is implemented by three separate hardware components: classifier 1112, serial PFRs logic 1114 and parallel PFRs logic 1116, each performing appropriate functions described in FIG. 4-6. In various embodiments, PFRs processing logic may be implemented in a system on a chip (SoC), within a processor, within a network interface card (NIC), or other hardware component.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASIC, programmable logic devices (PLD), digital signal processors (DSP), FPGA, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Included herein are logic flows or schemes representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow or scheme may be implemented in software, firmware, and/or hardware. In software and firmware embodiments, a logic flow or scheme may be implemented by computer executable instructions stored on at least one non-transitory computer readable medium or machine readable medium, such as an optical, magnetic or semiconductor storage. The embodiments are not limited in this context.

Some examples are described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a classifier to classify a received packet based at least in part on a header of the packet;
serial processing logic to apply one or more serial packet filter rules to the packet; and
parallel processing logic to apply one or more parallel packet filter rules to the packet when parallel packet filter rules are selected; wherein application of the serial packet filter rules is performed in parallel with application of the parallel packet filter rules.

2. The apparatus of claim 1, the apparatus to drop the packet when the packet fails any of the serial packet filter rules and to perform packet processing stages when the packet passes the serial packet filter rules.

3. The apparatus of claim 1, comprising a plurality of processing cores, application of the serial packet filter rules being executed by a first processing core, and application of the parallel packet filter rules being executed by one or more processing cores other than the first processing core.

4. The apparatus of claim 2, the apparatus to check status of completed packet filter rules and to drop the packet when the packet fails any of the packet filter rules.

5. The apparatus of claim 4, wherein the apparatus to transmit the packet when the packet passes all packet filter rules.

6. The apparatus of claim 1, the serial processing logic to apply at least one of basic level two and basic level three packet filter rules and to drop the packet when the packet fails any of the at least one of basic level two and basic level three packet filter rules.

7. The apparatus of claim 6, the serial processing logic to apply at least one of basic levels four through seven packet filter rules and to drop the packet when the packet fails any of the at least one of basic level four through seven packet filter rules.

8. The apparatus of claim 7, the parallel processing logic to apply at least one of extended levels two and three packet filter rules and to update packet metadata.

9. The apparatus of claim 8, the parallel processing logic to apply at least one of extended levels four through seven packet filter rules and to update packet metadata, wherein application of the extended levels two and three packet filter rules is executed in parallel with application of the extended levels four through seven, and in parallel with application of basic levels two and three and basic levels four through seven.

10. The apparatus of claim 1, the apparatus to detect an attack and, when an attack is detected, to apply extra security packet filter rules to the packet, wherein application of the extra security packet filter rules is performed in parallel with application of the serial packet filter rules and the parallel packet filter rules.

11. A method comprising:
receiving a packet;
classifying the packet based at least in part on a header of the packet;
applying one or more serial packet filter rules to the packet; and
when parallel packet filter rules are selected, applying one or more parallel packet filter rules to the packet; and
wherein applying the serial packet filter rules is performed in parallel with applying the parallel packet filter rules.

12. The method of claim 11, comprising dropping the packet when the packet fails any of the serial packet filter rules and performing packet processing stages when the packet passes the serial packet filter rules.

13. The method of claim 12, comprising checking status of completed packet filter rules and dropping the packet when the packet fails any of the packet filter rules.

14. The method of claim 13, comprising transmitting the packet when the packet passes all packet filter rules.

15. The method of claim 11, comprising applying at least one of basic level two and basic level three packet filter rules and dropping the packet when the packet fails any of the at least one of basic level two and basic level three packet filter rules.

16. The method of claim 15, comprising applying at least one of basic levels four through seven packet filter rules and dropping the packet when the packet fails any of the at least one of basic level four through seven packet filter rules.

17. The method of claim 16, comprising applying at least one of extended levels two and three packet filter rules and updating packet metadata.

18. The method of claim 17, comprising applying at least one of extended levels four through seven packet filter rules and to updating packet metadata, wherein applying extended levels two and three packet filter rules is performed in parallel with applying the extended levels four through seven, and in parallel with applying basic levels two and three and basic levels four through seven.

19. The method of claim 11, comprising detecting an attack and, when an attack is detected, applying extra security packet filter rules to the packet, wherein applying the extra security packet filter rules is performed in parallel with applying the serial packet filter rules and the parallel packet filter rules.

20. A processing system comprising:
a memory; and
processing logic coupled to the memory, the processing logic to receive a packet and store the packet in the memory, to classify the packet based at least in part on a header of the packet, to apply one or more serial packet filter rules to the packet, and when parallel packet filter rules are selected to apply one or more parallel packet filter rules to the packet, wherein application of the serial packet filter rules is performed in parallel with application of the parallel packet filter rules.

21. The processing system of claim 20, the processing logic to drop the packet when the packet fails any of the serial packet filter rules and to perform packet processing stages when the packet passes the serial packet filter rules.

22. The processing system of claim 21, the processing logic to check status of completed packet filter rules and to drop the packet when the packet fails any of the packet filter rules.

23. The processing system of claim 21, the processing logic to detect an attack and, when an attack is detected, to apply extra security packet filter rules to the packet, wherein application of the extra security packet filter rules is performed in parallel with application of the serial packet filter rules and the parallel packet filter rules.

24. The processing system of claim 21, wherein the processing logic comprises a router.

25. The processing system of claim 21, wherein the processing logic comprises a firewall.
